(19) United States
(12) Patent Application Publication
(10) Pub. No.: US 2013/0009998 A1
(43) Pub. Date: Jan. 10, 2013

(54) DISPLAY CONTROL SYSTEM

(76) Inventor: Chisen HSIEH, Taoyuan Hsien (TW)

(21) Appl. No.: 13/357,123

(22) Filed: Jan. 24, 2012

(30) Foreign Application Priority Data
Jul. 5, 2011 (CN) 201110198522.3

(51) Int. Cl. G09G 5/00

(52) U.S. Cl. 345/667; 345/1.1

(57) ABSTRACT

A display control system is provided. The display control system is electrically coupled to a first display device, a second display device and an image output device which is configured to generate an image. The display control system comprises a control unit, a first control device and a second control device. The first control device is configured to retrieve a first portion of the image according to a first image control command transmitted from the control unit and to display the first portion on the first display device. The second control device is configured to retrieve a second portion of the image according to the second image control command transmitted from the control unit and to display the second portion on the second display device.

This application claims priority to China Patent Application No. 201110198522.3 filed on Jul. 5, 2011, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a display control system; and more particularly, the display control system of the present invention accomplishes displaying of an image on a plurality of display devices by using a plurality of control devices corresponding to the display devices.

2. Descriptions of the Related Art

The conventional video wall display technology is primarily implemented by using a plurality of display devices in combination with a single computer having an image processing capability. In order to display an image on a video wall correctly, the image must be firstly processed by the computer appropriately. In other words, because the video wall has a plurality of display devices, the image must be divided firstly in order to display the image on the display devices. Further speaking, the computer may divide the image to be displayed depending on the user's desire and then output partial images obtained through the division to corresponding display devices of the video wall. Thus, by using the plurality of display devices, the image can be recombined for display on the video wall.

However, when the image is displayed on the video wall in the aforesaid way, the displaying quality is determined by performance of the computer that processes the image. Specifically, when an image is to be displayed on a video wall, the larger the number of display devices is, the greater the burden on the computer in processing the image will be. More specifically, as the number of display devices used increases, more complex picture arrangement calculations must be made by the computer apart from dividing the image more finely. Moreover, when several pictures are to be displayed on the video wall in a picture-in-picture mode simultaneously, the computational burden on the computer will be multiplied. Consequently, if it is desired to obtain a good image displaying quality on the video wall, the computer must be made at a significantly higher hardware cost.

Accordingly, an urgent need exists in the art to solve the aforesaid problems with the prior art that the displaying performance of the video wall is limited by a single computer and that the hardware cost is high.

### SUMMARY OF THE INVENTION

An objective of the present invention is to provide a display control system, which can process display frames individually by use of control devices connected to display devices so that the efficiency of displaying an image on a video wall can be significantly increased and the hardware cost can be reduced.

To achieve the aforesaid objective, the present invention provides a display control system, which is electrically coupled to a first display device, a second display device and at least one image output device. The at least one image output device comprises a first image output device, and the display control system comprises a control unit, a first control device and a second control device.

The first control device comprises a first image output terminal, a first image input terminal and a first processing unit. The first image output terminal is electrically coupled to the first display device. The first image input terminal is electrically coupled to the first image output device and is configured to receive a first image generated by the first image output device. The first processing unit is electrically coupled to the first image input terminal and the first image output terminal, and has a first connection with the control unit. The first processing unit is configured to receive the first image from the first image input terminal, to retrieve a first portion of the first image according to a first image control command transmitted by the control unit via the first connection, and to transmit the first portion of the first image to the first display device via the first image output terminal so that the first display device displays the first portion of the first image.

The second control device comprises a second image output terminal, a second image input terminal and a second processing unit. The second image output terminal is electrically coupled to the second display device. The second image input terminal is electrically coupled to the first image output device and is configured to receive a first image generated by the first image output device. The second processing unit is electrically coupled to the second image input terminal and the second image output terminal, and has a second connection with the control unit. The second processing unit is configured to receive the first image from the second image input terminal, to retrieve a second portion of the first image according to the first image control command transmitted by the control unit via the second connection, and to transmit the second portion of the first image to the second display device via the second image output terminal so that the second display device displays the second portion of the first image.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a display control system according to a first embodiment of the present invention;

FIG. 2A is a schematic view of a first control device according to the first embodiment of the present invention;

FIG. 2B is a schematic view of a second control device according to the first embodiment of the present invention;

FIG. 3 is a schematic view of a display control system according to a second embodiment of the present invention;

FIG. 4A is a schematic view of a first control device according to the second embodiment of the present invention;

FIG. 4B is a schematic view of a second control device according to the second embodiment of the present invention;

FIG. 5 is a schematic view illustrating how a first display device and a second display device display an image according to the second embodiment of the present invention;

FIG. 6 is a schematic view of a display control system according to a third embodiment of the present invention;

FIG. 7A is a schematic view of a third control device according to the third embodiment of the present invention;

FIG. 7B is a schematic view of a fourth control device according to the third embodiment of the present invention; and

FIG. 8 is a schematic view illustrating how a first display device, a second display device, a third display device and a fourth display device display an image according to the third embodiment of the present invention.

### DESCRIPTION OF THE PREFERRED EMBODIMENT

In the following description, the present invention will be explained with reference to embodiments thereof However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction.

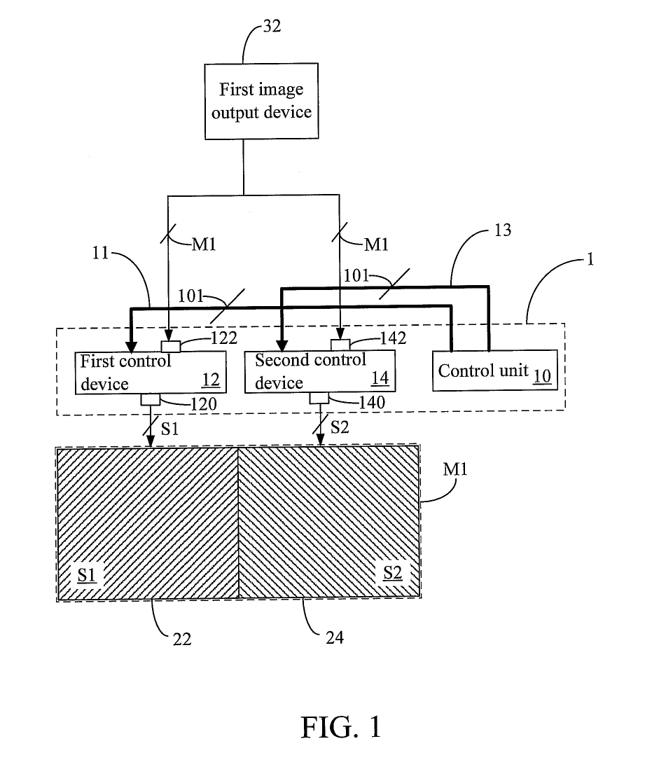

Referring to FIG. 1 firstly, there is shown a schematic view of a display control system 1 according to a first embodiment of the present invention. The display control system 1 comprises a control unit 10, a first control device 12 and a second control device 14. The display control system 1 is electrically coupled to a first display device 22, a second display device 24 and at least one image output device. It shall be appreciated that, in the first embodiment, the at least one image output device comprises a first image output device 32, which may be a device capable of outputting an image such as a video camera or a video player although this is not intended to limit the type or the number of the image output device(s).

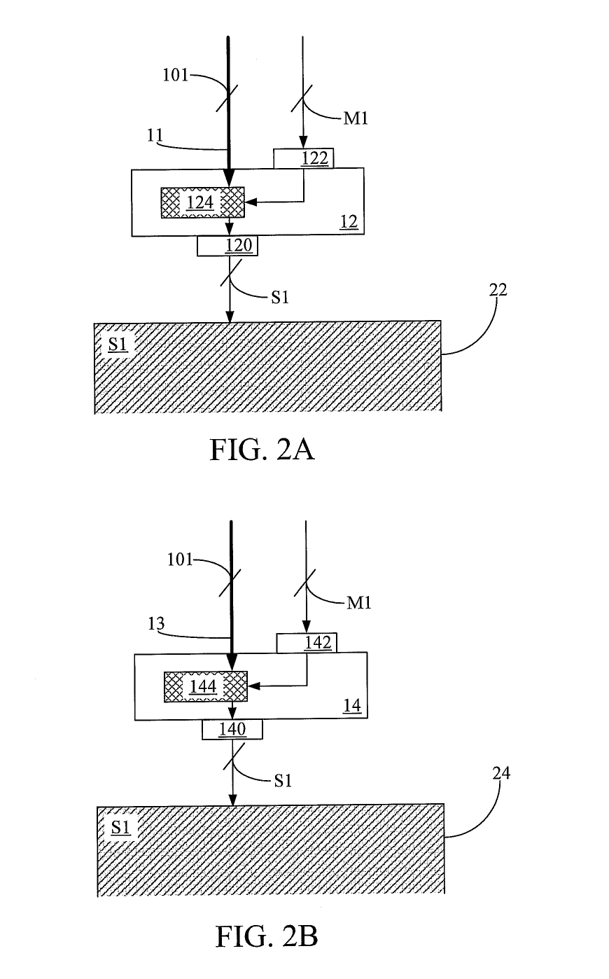

Referring to FIG. 2A and FIG. 2B together, there are shown a schematic view of a first control device 12 and a schematic view of a second control device 14 respectively according to the first embodiment of the present invention. The first control device 12 comprises a first image output terminal 120, a first image input terminal 122 and a first processing unit 124. The second control device 14 comprises a second image output terminal 140, a second image input terminal 142 and a second processing unit 144. Hereinafter, connection relationships and functions of these components of the devices will be illustrated in detail.

Specifically, in terms of external connections, the first control device 12 is electrically coupled to the first display device 22 via the first image output terminal 120, and is electrically coupled to the first image output device 32 via the first image input terminal 122 to receive a first image M1 generated by the first image output device 32. In terms of the internal structure of the first control device 12, the first processing unit 124 of the first control device 12 is electrically coupled to the first image output terminal 120 and the first image input terminal 122, and has a first connection 11 with the control unit 10.

Similarly, in terms of external connections, the second control device 14 is electrically coupled to the second display device 24 via the second image output terminal 140, and is electrically coupled to the first image output device 32 via the second image input terminal 142 to receive the first image M1 generated by the first image output device 32. In terms of the internal structure of the second control device 14, the second processing unit 144 of the second control device 14 is electrically coupled to the second image output terminal 140 and the second image input terminal 142 and has a second connection 13 with the control unit 10. It shall be appreciated that, the first connection 11 and the second connection 13 are used to transmit information and may be implemented in either a wireless or a wired way.

Thus, the connection relationships have been described above. Then, when a user desires to control the first display device 22 and the second display device 24 to display the first image M1, the user can utilize the control unit 10 to transmit a first image control command 101 to the first processing unit 124 and the second processing unit 144 simultaneously via the first connection 11 and the second connection 13 respectively so as to process the first image M1. In other words, the first processing unit 124 and the second processing unit 144 can both receive the first image control command 101 from the control unit 10 via the first connection 11 and the second connection 13 respectively so that the first processing unit 124 processes the first image M1.

Further speaking, the first image control command 101 contains information related to the way in which the user desires to display the first image M1 on the first display device 22 and the second display device 24. Therefore, after receiving the first image control command 101, the first processing unit 124 of the first control device 12 retrieves a first portion S1 of the first image M1 received from the first image input terminal 122 according to the first image control command 101, and transmits the first portion S1 of the first image M1 to the first display device 22 via the first image output terminal 120 so that the first display device 22 displays the first portion S1 of the first image M1.

Similarly, after receiving the first image control command 101, the second processing unit 144 of the second control device 14 retrieves a second portion S2 of the first image M1 received from the second image input terminal 142 according to the first image control command 101, and transmits the second portion S2 of the first image M1 to the second display device 24 via the second image output terminal 140 so that the second display device 24 displays the second portion S2 of the first image M1.

Further speaking, the first image control command 101 generated by the control unit 10 further contains information related to division sizes of the image, which is used to determine sizes of the first portion S1 and the second portion S2 of the first image M1. By way of example, in the first embodiment, the first portion S1 of the first image M1 may be a left half of the first image M1, and the second portion S2 of the first image M1 may be a right half of the first image M1.

Thus, when the first portion S1 is displayed on the first display device 22 disposed at the left side and the second portion S2 is displayed on the second display device 24 disposed at the right side, the first image M1 can be completely displayed on the video wall (i.e., the screen formed by the first display device 22 and the second display device 24).

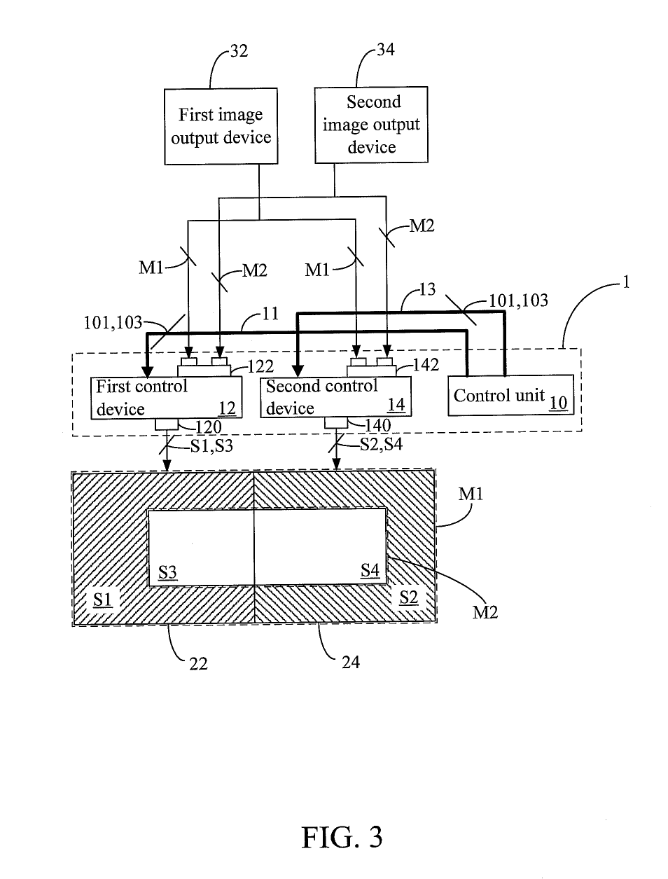

Next, referring to FIG. 3, there is shown a schematic view of a display control system 1 according to a second embodiment of the present invention. Components of the second embodiment are substantially the same as those of the first embodiment, so connection relationships and functions of the components of the second embodiment will not be further described again. The second embodiment differs from the first embodiment mainly in that, in the second embodiment, the at least one image output device further comprises a second image output device 34, and the first image input terminal 122 of the first control device 12 and the second image input terminal 142 of the second control device 14 are both further electrically coupled to the second image output device 34 to receive a second image M2 generated by the second image output device 34. It shall be particularly appreciated that, because the first control device 12 and the second control device 14 are configured to receive two images respectively in the second embodiment, the image input terminals of the first control device 12 and the second control device 14 may be implemented in different forms.

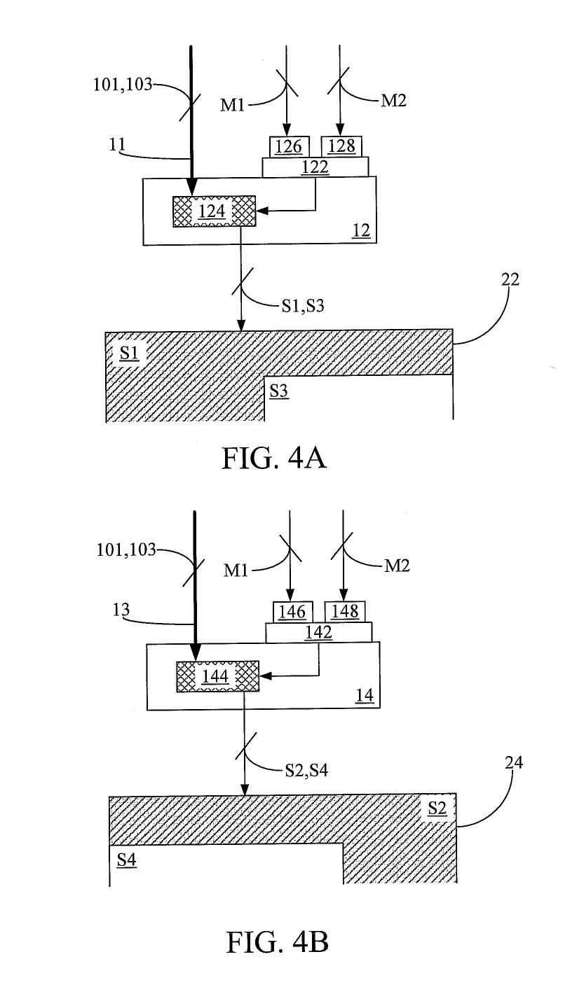

Referring to FIG. 4A and FIG. 4B together, there are shown a schematic view of a first control device 12 and a schematic view of a second control device 14 respectively according to the second embodiment of the present invention. Specifically, the first image input terminal 122 may comprise a first connection port 126 electrically coupled to the first image output device 32 and a second connection port 128 electrically coupled to the second image output device 34 so as to receive the first image M1 and the second image M2 respectively. Similarly, the second image input terminal 142 may also comprise a first connection port 146 electrically coupled to the first image output device 32 and a second connection port 148 electrically coupled to the second image output device 34 so as to receive the first image M1 and the second image M2 respectively.

Next, with the arrangement described above, when a user desires to control the first display device 22 and the second display device 24 to display the second image M2 simultaneously, the user can utilize the control unit 10 to transmit a second image control command 103 to the first processing unit 124 and the second processing unit 144 via the first connection 11 and the second connection 13 respectively so as to process the second image M2. In other words, the first processing unit 124 and the second processing unit 144 can receive the second image control command 103 from the control unit 10 via the first connection 11 and the second connection 13 respectively so that the second processing unit 144 processes the second image M2.

Further speaking, the second image control command 103 further contains information related to the way in which the user desires to display the second image M2 on the first display device 22 and the second display device 24. Therefore, after receiving the second image control command 103, the first processing unit 124 of the first control device 12 retrieves a first portion S3 of the second image M2 received from the first image input terminal 122 according to the second image control command 103, and transmits the first portion S3 of the second image M2 to the first display device 22 via the first image output terminal 120 so that the first display device 22 displays the first portion S3 of the second image M2.

Similarly, after receiving the second image control command 103, the second processing unit 144 of the second control device 14 retrieves a second portion S4 of the second image M2 received from the second image input terminal 142 according to the second image control command 103, and transmits the second portion S4 of the second image M2 to the second display device 24 via the second image output terminal 140 so that the second display device 24 displays the second portion S4 of the second image M2.

It shall be particularly appreciated that, the first image M1 and the second image M2 can be displayed on the first display device 22 and the second display device 24 simultaneously, and in the second embodiment, the second image M2 is displayed with a priority over the first image M1. Specifically, as shown, if both the first portion S3 of the second image M2 and the first portion S1 of the first image M1 are to be displayed on a same block of the first display device 22, then the first portion S3 of the second image M2 will be displayed with a priority over the first portion S1 of the first image M1; on the other hand, if both the second portion S4 of the second image M2 and the second portion S2 of the first image M1 are to be displayed on a same block of the second display device 24, then the second portion S4 of the second image M2 will be displayed with a priority over the second portion S2 of the first image M1.

Similarly, the first image control command 101 and the second image control command 103 generated by the control unit 10 further contain information related to division sizes of the portions of the images, which is used to determine sizes of the first portion S1 and the second portion S2 of the first image M1 as well as sizes of the first portion S3 and the second portion S4 of the second image M2.

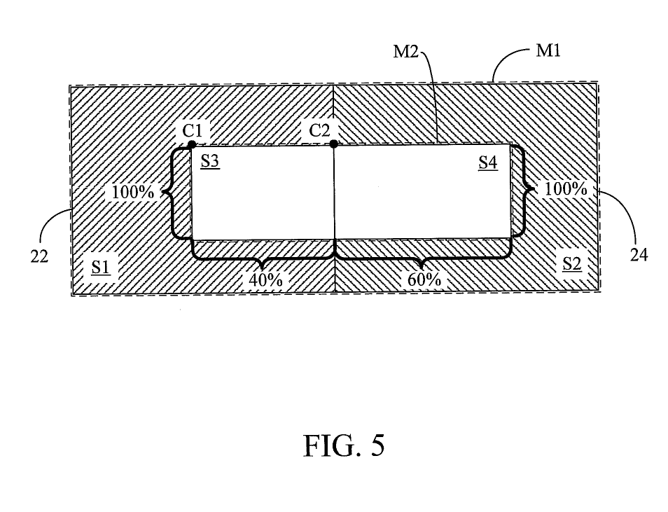

By way of example, referring to FIG. 5 together, there is shown a schematic view illustrating how the first display device 22 and the second display device 24 display images according to the second embodiment of the present invention. Specifically, in the second embodiment, the first portion S1 and the second portion S2 of the first image M1 can be displayed on the video wall in the same way as described in the first embodiment, so no further description will be made herein. On the other hand, because the second image control command 103 contains the information related to the displaying size of the second image M2 (in the second embodiment, the displaying size of the second image M2 is a quarter of the size of the whole screen formed by the first display device 22 and the second display device 24) and the second image M2 is displayed with a priority over the first image M1, the first image M1 and the second image M2 will be displayed in forms of a primary picture and a sub-picture respectively on the first display device 22 and the second display device 24.

Next, because the second image control command 103 contains the information related to division sizes and coordinates of the images, the first processing unit 124 of the first control device 12 can retrieve the first portion S3 (i.e., a left section which occupies 40% of the length and 100% of the width of the second image M2) of the second image M2 according to the information related to the division sizes of the images, and take a coordinate C1 as a starting point for displaying the first portion S3 according to the information related to the coordinates of the images. Similarly, the second processing unit 144 of the second control device 14 can retrieve the second portion S4 (i.e., a right section which occupies 60% of the length and 100% of the width of the second image M2) of the second image M2 according to the information related to the division sizes of the images, and take a coordinate C2 as a starting point for displaying the second portion S4 according to the information related to the coordinates of the images.

With the aforesaid arrangement, when the first portion S3 and the second portion S4 are displayed on the first display device 22 disposed at the left side and on the second display device 24 disposed at the right side respectively, the second image M2 can be displayed on the video wall (i.e., the screen formed by the first display device 22 and the second display device 24) completely. Thus, the first image M1 and the second image M2 can be displayed completely and correctly in forms of a primary picture and a sub-picture respectively on the first display 22 and on the second display 24.

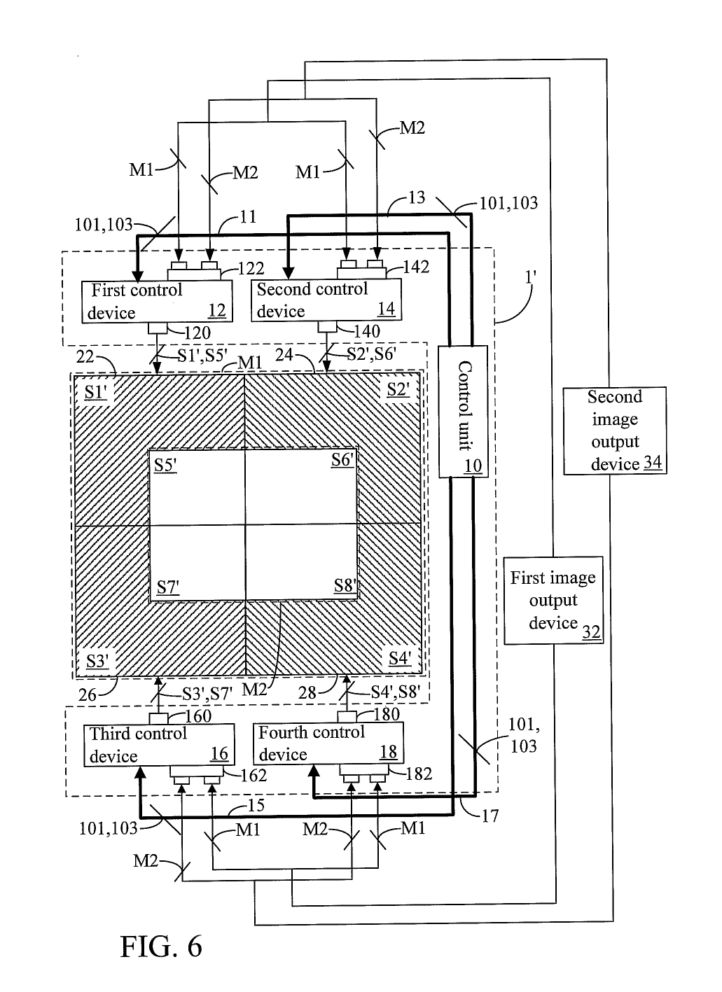

Referring to FIG. 6, there is shown a schematic view of a display control system 1′ according to a third embodiment of the present invention. Connection relationships and functions of the components that are identical to those of the second embodiment will not be further described again herein. It shall be particularly appreciated that, the third embodiment differs from the second embodiment mainly in that, the display control system 1′ of the third embodiment additionally comprises a third control device 16 and a fourth control device 18.

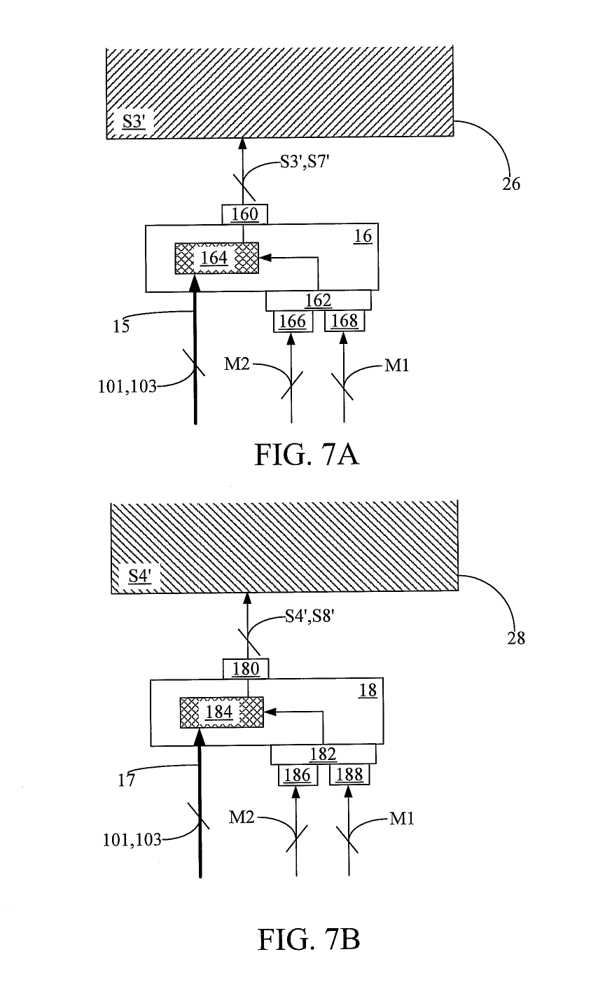

Referring to FIG. 7A and FIG. 7B together, there are respectively shown a schematic view of the third control device 16 and a schematic view of the fourth control device 18 according to the third embodiment of the present invention. Similarly, the third control device 16 comprises a third image output terminal 160, a third image input terminal 162 and a third processing unit 164. The third processing unit 164 is electrically coupled to a third display device 26 via the third image output terminal 160, and is electrically coupled to the first image output device 32 and the second image output device 34 through a first connection port 166 and a second connection port 168 included in the third image input terminal 162 to receive the first image M1 and the second image M2. In terms of the internal structure, the third processing unit 164 of the third control device 16 is electrically coupled to the third image output terminal 160 and the third image input terminal 162, and has a third connection 15 with the control unit 10.

Similarly, the fourth control device 18 comprises a fourth image output terminal 180, a fourth image input terminal 182 and a fourth processing unit 184. The fourth processing unit 184 is electrically coupled to a fourth display device 28 via the fourth image output terminal 180, and is electrically coupled to the first image output device 32 and the second image output device 34 through a first connection port 186 and a second connection port 188 included in the fourth image input terminal 182 to receive the first image M1 and the second image M2 respectively. In terms of the internal structure, the fourth processing unit 184 of the fourth control device 18 is electrically coupled to the fourth image output terminal 180 and the fourth image input terminal 182 and has a fourth connection 17 with the control unit 10.

Similarly, in the same way as the first embodiment and the second embodiment, the third processing unit 164 receives the first image control command 101 and the second image control command 103 from the control unit 10 via the third connection 15, and retrieves a third portion S3′ of the first image M1 and a third portion S7′ of the second image M2 according to the first image control command 101 and the second image control command 103 respectively. Likewise, the fourth processing unit 184 receives the first image control command 101 and the second image control command 103 from the control unit 10 via the fourth connection 17, and retrieves a fourth portion S4′ of the first image M1 and a fourth portion S8′ of the second image M2 according to the first image control command 101 and the second image control command 103 respectively.

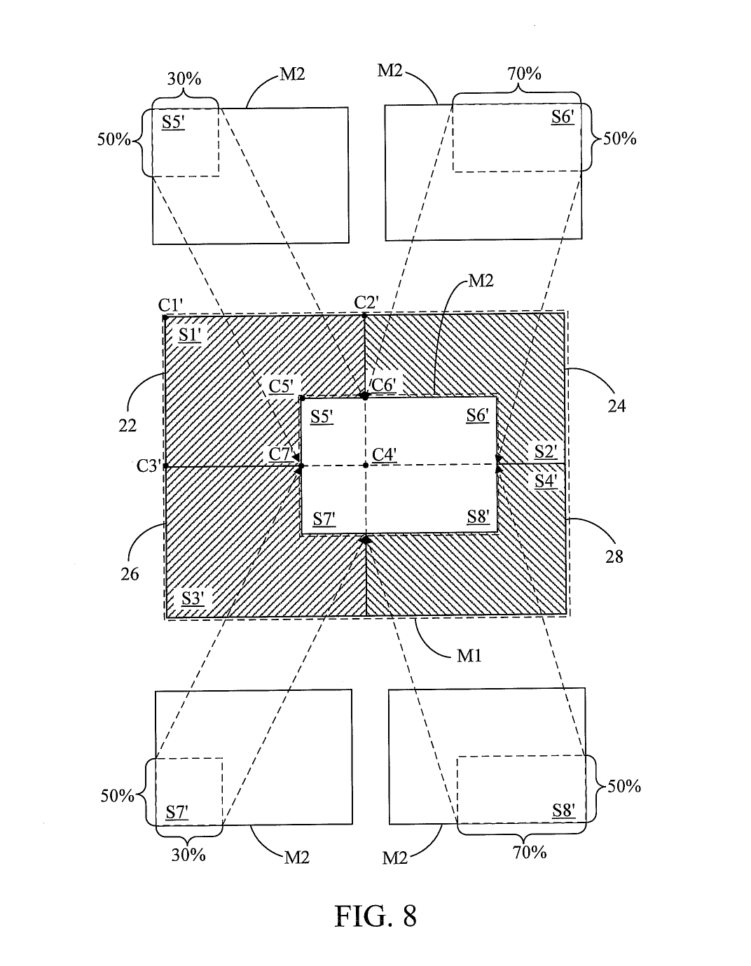

Next, referring to FIG. 8 together, there is shown a schematic view illustrating how the firs display device 22, the second display device 24, the third display device 26 and the fourth display device 28 display images according to the third embodiment of the present invention. In detail, the first image control command 101 generated by the control unit 10 is used to determine a size of the first image M1 (in the third embodiment, the size of the first image M1 is just the size of the whole screen formed by the first display device 22, the second display device 24, the third display device 26 and the fourth display device 28) and displaying locations of the first portion S1′, the second portion S2′, the third portion S3′ and the fourth portion S4′ of the first image M1 on the first display device 22, the second display device 24, the third display device 26 and the fourth display device 28 respectively.

Furthermore, because the first image control command 101 further contains information related to division sizes and coordinates of the images, the first processing unit 124 of the first control device 12 can retrieve the first portion S1′ (i.e., the upper-left quarter of the first image M1) of the first image M1 according to the information related to the division sizes of the images, and take a coordinate C1′ as a starting point for displaying the first portion S1′ according to the information related to the coordinates of the images. The second processing unit 144 can retrieve the second portion S2′ (i.e., the upper-right quarter of the first image M1) of the first image M1 according to the information related to the division sizes of the images, and take a coordinate C2′ as a starting point for displaying the second portion S2′ according to the information related to the coordinates of the images.

Similarly, the third processing unit 164 can retrieve the third portion S3′ (i.e., the lower-left quarter of the first image M1) of the first image M1 according to the information related to the division sizes of the images, and take a coordinate C3′ as a starting point for displaying the third portion S3′ according to the information related to the coordinates of the images. The fourth processing unit 184 can retrieve the fourth portion S4′ (i.e., the lower-right quarter of the first image M1) of the first image M1 according to the information related to the division sizes of the images, and take a coordinate C4′ as a starting point for displaying the fourth portion S4′ according to the information related to the coordinates of the images.

In this way, when the first portion S1′ is displayed on the first display device 22 disposed at the upper-left side, the second portion S2′ is displayed on the second display device 24 disposed at the upper-right side, the third portion S3′ is displayed on the third display device 26 disposed at the lower-left side and the fourth portion S4′ is displayed on the fourth display device 28 disposed at the lower-right side, the first image M1 can be displayed completely on the video wall (i.e., the screen formed by the first display device 22, the second display device 24, the third display device 26 and the fourth display device 28).

Similarly, the second image control command 103 is used to determine a size of the second image M2 (which is equal to a quarter of the size of the whole screen formed by the first display device 22, the second display device 24, the third display device 26 and the fourth display device 28 in the third embodiment) and displaying locations of the first portion S5′, the second portion S6′, the third portion S7′ and the fourth portion S8′ of the second image M2 on the first display device 22, the second display device 24, the third display device 26 and the fourth display device 28 respectively.

Next, because the second image control command 103 further contains the information related to division sizes and coordinates of the images, the first processing unit 124 of the first control device 12 can retrieve the first portion S5′ (i.e., the upper-left section which occupies 30% of the length and 50% of the width of the second image M2) of the second image M2 according to the information related to the division sizes of the image, and take a coordinate C5′ as a starting point for displaying the first portion S5′ according to the information related to the coordinates of the images. The second processing unit 144 of the second control device 14 can retrieve the second portion S6′ (i.e., the upper-right section which occupies 70% of the length and 50% of the width of the second image M2) of the second image M2 according to the information related to the division sizes of the images, and take a coordinate C6′ as a starting point for displaying the second portion S6′ according to the information related to the coordinates of the images.

Similarly, the third processing unit 164 of the third control device 16 can retrieve the third portion S7′ (i.e., the lower-left section which occupies 30% of the length and 50% of the width of the second image M2) of the second image M2 according to the information related to the division sizes, and take a coordinate C7′ as a starting point for displaying the third portion S7′ according to the information related to the coordinates of the images. The fourth processing unit 184 of the fourth control device 18 can retrieve the fourth portion S8′ (i.e., the lower-right section which occupies 70% of the length and 50% of the width of the second image M2) of the second image M2 according to the information related to the division sizes, and take a coordinate C8′ as a starting point for displaying the fourth portion S8′ according to the information related to the coordinates of the images.

Thus, when the first portion S5′, the second portion S6′, the third portion S7′ and the fourth portion S8′ are displayed on the first display device 22, the second display device 24, the third display device 26 and the fourth display device 28 respectively in the aforesaid manner, the second image M2 can be displayed completely on the video wall (i.e., the screen formed by the first display device 22, the second display device 24, the third display device 26 and the fourth display device 28). Thereby, the first image M1 and the second image M2 can be completely and correctly displayed in forms of a primary picture and a sub-picture on the first display device 22, the second display device 24, the third display device 26 and the fourth display device 28.

According to the above descriptions, the display control system of the present invention can process information related to frames displayed on the video wall at a low cost and effectively by distributing the computational burden among a plurality of control devices having basic image processing functions. Thereby, the problem in the prior art with too much image processing has to be undertaken by a single computer to cause a heavy burden and high hardware cost can be easily overcome.

The above disclosure is related to the detailed technical contents and inventive features thereof. People skilled in this field may proceed with a variety of modifications and replacements based on the disclosures and suggestions of the invention as described without departing from the characteristics thereof Nevertheless, although such modifications and replacements are not fully disclosed in the above descriptions, they have substantially been covered in the following claims as appended.

What is claimed is:

1. A display control system, being electrically coupled to a first display device, a second display device and at least one image output device, the at least one image output device comprising a first image output device, and the display control system comprising:
a control unit;
a first control device, comprising:
a first image output terminal, which is coupled to the first display device electrically;
a first image input terminal, which is coupled to the first image output device electrically, being configured to receive a first image generated by the first image output device; and
a first processing unit, which is coupled to the first image input terminal and the first image output terminal electrically, having a first connection with the control unit, being configured to receive the first image from the first image input terminal, to retrieve a first portion of the first image according to a first image control command transmitted by the control unit via the first connection, and to transmit the first portion of the first image to the first display device via the first image output terminal so that the first display device displays the first portion of the first image;
a second control device comprising:
a second image output terminal, which is coupled to the second display device electrically;
a second image input terminal, which is coupled to the first image output device electrically, being configured to receive the first image generated by the first image output device; and
a second processing unit, which is coupled to the second image input terminal and the second image output terminal electrically, having a second connection with the control unit, being configured to receive the first image from the second image input terminal, to retrieve a second portion of the first image according to the first image control command transmitted by the control unit via the second connection, and to transmit the second portion of the first image to the second display device via the second output terminal so that the second display device displays the second portion of the first image.

2. The display control system as claimed in claim 1, wherein the first image control command transmitted by the control unit is further configured to determine sizes of the first portion and the second portion of the first image, and to determine display locations of the first portion and the second portion of the first image on the first display device and the second display device respectively.

3. The display control system as claimed in claim 1, wherein the at least one image output device further comprises a second image output device, the first image input terminal is further coupled to the second image output device electrically and receives a second image generated by the second image output device, the first processing unit is further configured to retrieve a first portion of the second image according to a second image control command transmitted by the control unit via the first connection, and to transmit the first portion of the second image to the first display device via the first image output terminal so that the first display device displays the first portion of the second image;
wherein the first portion of the second image is partially displayed prior to the first portion of the first image at least.

4. The display control device as claimed in claim 3, wherein the second image input terminal is further coupled to the second image output device electrically and receives the second image generated by the second image output device, the second processing unit is further configured to retrieve a second portion of the second image according to the second image control command transmitted by the control unit via the second connection, and to transmit the second portion of the second image via the second image output terminal to the second display device so that the second display device displays the second portion of the second image;
wherein the second portion of the second image is partially displayed prior to the second portion of the first image at least.

5. The display control device as claimed in claim 4, wherein the second image control command transmitted by the control unit is further configured to determine sizes of the first portion and the second portion of the second image, and to determine display locations of the first portion and the second portion of the second image on the first display device and the second display device respectively.

6. The display control device as claimed in claim 3, wherein the first image input terminal comprises a first connection port and a second connection port, the second image input terminal comprises a first connection port and a second connection port, the first connection port and the second connection port of the first image input terminal are electrically coupled to the first image output device and the second image output device respectively, and the first connection port and the second connection port of the second image input terminal are electrically coupled to the first image output device and the second image output device respectively.
